(19) United States
(12) Patent Application Publication
(10) Pub. No.: US 2023/0346039 A1
(43) Pub. Date: Nov. 2, 2023

(54) MEASURING THE TEMPERATURE OF A HEATING ELEMENT OF AN ELECTRONIC CIGARETTE

(71) Applicant: SmokerStore GmbH, Schwelm (DE)

(72) Inventors: Clas GURTNER, Kierspe (DE); Oliver SIMON, Wuerselen (DE); Jaroslaw DOBRAS, Hagen (DE); Michael KOSCHOLLEK, Ennepetal (DE)

(73) Assignee: SmokerStore GmbH, Schwelm (DE)

(21) Appl. No.: 18/221,104

(22) Filed: Jul. 12, 2023

Related U.S. Application Data
(63) Continuation of application No. PCT/IB2022/050213, filed on Jan. 12, 2022.

(30) Foreign Application Priority Data
Jan. 12, 2021 (DE) 10 2021 100 441.1

(51) Int. Cl. A24F 40/51; G01K 7/08; G01K 1/02; G05D 23/22; H05B 1/02; A24F 40/10; A24F 40/46; A24F 40/57

(52) U.S. Cl. CPC A24F 40/51; G01K 7/08; G01K 1/026; G05D 23/22; H05B 1/0244; A24F 40/10; A24F 40/46; A24F 40/57; H05B 2203/021

(57) ABSTRACT

A vaporizer for vaporizing a liquid comprises a heating element for receiving electrical power and for delivering thermal power to a liquid to be vaporized and a temperature sensor for sensing the temperature of the heating element. The temperature sensor and the heating element are directly mechanically connected and thermally coupled.

This nonprovisional application is a continuation of International Application No. PCT/IB2022/050213, which was filed on Jan. 12, 2022, and which claims priority to German Patent Application No. 10 2021 100 441.1, which was filed in Germany on Jan. 12, 2021, and which are both herein incorporated by reference.

### BACKGROUND OF THE INVENTION

### Field of the Invention

The present application relates to the detection of the temperature of a heating element of an electronic cigarette or another electric smoking or vaporizing system for vaporizing a liquid and generation of an inhalable aerosol and to an electronic cigarette or another electric smoking or vaporizing system.

### Description of the Background Art

Smoking cigarettes, cigars and tobacco pipes involves the smoldering to glowing combustion of tobacco. Thereby, not only nicotine and desirable flavors are released or generated and inhaled but also numerous other substances. Many substances generated and inhaled during smoking are irritating, blood toxical, neurotoxical and/or carcinogen. Therefore, starting in the second half of the 20th century, ideas are developed for evaporation of nicotine and flavors in an inhalable air flow without burning tobacco (confer U.S. Pat. No. 3,200,819).

In current designs of electronic cigarettes (also referred to as electric cigarettes or e-cigarettes; in German: E-Zigarette) a liquid optionally comprising flavors and nicotine can be vaporized or sprayed by electrical heating and/or high-frequency acoustic waves. Utilizing an electronic cigarette is frequently referred to as vaping rather than smoking because an electronic cigarette does not produce classical combustion smoke but vapor. Therefore, hereafter, the terms “electric smoking system” and “electric vaping system” are used as synonyms.

In WO 2020/212009 A1 a heating element for a system for providing an inhalable aerosol, in particular for an electronic cigarette, is described. A chip can comprise a heating structure and a temperature sensor on a carrier substrate. A heating element comprises a temperature sensor on a main body besides a heating structure. The temperature sensor can be connected to evaluating electronics and transmit the current temperature of the heating structure to the evaluating electronics.

In EP 3 626 093 A1, also published as WO 2020/061365 A1, and which also corresponds to US 2021/0392955, a heating element for a system for providing an inhalable aerosol, in particular an electronic cigarette, is described. The heating element has a heating structure on a main body made of an electrically insulating material and a cover layer fixing the heating structure to the main body. The heating structure is a heating resistor made of a metal wire. The cover layer is electrically insulating. The heating element comprises a temperature sensor located on the heating structure and transmitting the current temperature of the heating structure to evaluating electronics.

In DE 10 2017 111 119 A1, a vaporizer unit for an inhaler, in particular for an electronic cigarette, is described. An open loop or closed loop temperature control of a heating element is based on a measurement of the electric resistance of the heating element or on a temperature sensor.

In WO 2020/216198 A1, an electronic cigarette with a heating element and a temperature sensor is described, wherein the temperature sensor partially surrounds the heating element.

In WO 2020/182772 A1 an aerosol generating device is described. At each of (inductively heated) heating elements, a temperature sensor, in particular a thermocouple is provided. The temperature data detected by the temperature sensors are transmitted to a controller which can comprise a PID control and controls the power supply.

In EP 2 654 471 B1 (also published as WO 2012/085205 A1, which corresponds to US 2013/0306084) a system generating aerosol is described. The temperature of the heating means is detected by a temperature sensor coupled to a control circuit generating a turn-off signal when the detected temperature exceeds a temperature threshold.

In WO 2020/069030 A1, which corresponds to US 2022/0074586, a device for thin-film capillary evaporation is described. A thermocouple on a surface of a heating device (namely CFV=capillary force vaporizer) is used to detect the temperature and control the heating means.

In DE 10 2017 222 528 B3 a heating unit for a system for providing an inhalable aerosol is described. A heating element and a temperature sensor element are arranged on a substrate.

In WO 2016/115689 A1 a circuit for changing the equivalent resistance of a heating wire of a vaporizer is described. A temperature detection circuit detects the temperature of a heating wire. The temperature detection circuit detects the temperature by means of a thermistor or a thermocouple.

In JP 2000041654 A an electric heater controlling system for a flavor producing device is described. A temperature sensor is attached to a surface of a heater, the temperature detected by the temperature sensor is used by a heater controlling device.

In DE 10 2016 002 665 A1, which corresponds to US 2020/205478, an electronic cigarette product is described. A sensor is provided for measurement and/or control of the temperature of a heating plate, the sensor comprising a temperature probe or a conductive coating with changing resistance on the heating plate.

Measurement of the electric resistance and, thus, the temperature of the resistance changing conductive coating of the electrically conductive heating plate is possible only if the resistance changing conductive coating is isolated from the heating plate by an electrically insulating layer.

In US 2020/0163378 A1, a wearable and controllable device for generating an inhalable vapor is described. A thermocouple can be located in an air flow downstream a heater for detecting or controlling the air temperature.

In US 2020/0345070 A1, a tobacco vaporizer and a heater control method are described. For detection of the temperature of a chamber containing a heating element, a temperature sensor is welded to an exterior wall of a body of the chamber.

In US 2019/0124985 A1, a vaporizer with a heating element with several heating regions and a corresponding number of temperature sensors thermally conductively connected to the heating regions is described.

In WO 2018/202730 A1, which corresponds to US 2021/0112879, an electric connector of an electrically driven aerosol generating system is described. A plurality of arrangements of contacts of the electrical connector are shown.

### SUMMARY OF THE INVENTION

It is therefore an object of the present invention to provide an improved detection of the temperature of a heating element of an electronic cigarette or another device for vaporizing a liquid.

An exemplary vaporizer for vaporizing a liquid comprises a heating element for receiving electrical power and for delivering thermal power to a liquid to be vaporized, and a temperature sensor for detecting the temperature of the heating element, wherein the temperature sensor and the heating element are directly mechanically connected and thermally coupled.

The vaporizer is provided for and configured to be part of an electronic cigarette or for an electronic cigarette or for another electric smoking or vaping system. The vaporizer can be configured as a vaporizer module that, together with a power source module, may already form a complete and operable electronic cigarette or another complete and operable electric smoking or vaporizing system. As an alternative, the vaporizer is provided and configured to form, together with one or more other components—for example a housing—a vaporizer module in the sense described above.

In particular, the temperature sensor and the heating element are directly connected without any electrically insulating device or any electrically insulating material layer.

The direct mechanical connection and thermal coupling of the temperature sensor and the heating element can facilitate a particularly cost-effective production. Furthermore, the direct mechanical connection and thermal coupling can reduce the thermal inertia and, thereby, facilitate a particularly fast and precise control of a temperature of the heating element.

In a vaporizer as described herein, the temperature sensor and the heating element are in particular connected electrically conductively.

Several joining methods producing an electrically conductive connection are particularly cost-efficient and/or produce a connection with a particularly low mass or particular thermal conductivity, facilitating a precise and fast control of the temperature of the heating element.

In a vaporizer as it is described herein, the temperature sensor in particular comprises the sensing junction of a thermocouple.

The sensing junction of a thermocouple can be formed of an electrically conductive, usually directly, by means of a weld, connection between two wires or other devices from different metals. Due to the Seebeck effect, a voltage depending on the temperature of the sensing junction is generated at the junction between both materials. A closed circuit necessarily comprises at least two such junctions between different materials. The difference between the thermoelectric voltages depending on the temperatures of the junctions can be measured. If all junctions provide the same temperature, the difference of the thermoelectric voltages vanishes.

Usually at the sensing junction the temperature of which is to be detected, two wires from different metals, for example nickel-chromium or nickel or iron or copper-nickel or platinum-rhodium or platinum, are welded to each other. At a different place, referred to as reference junction, both wires are connected to conductors made of copper, which in turn connect the reference junction to a measuring device for detection of the voltage. The temperature of the reference junction is detected by means of a further temperature sensor, for example a temperature dependent resistor.

Thermocouples can be produced very cost-effectively and almost arbitrarily small with correspondingly low mass and correspondingly low thermal inertia. Thermocouples can be mechanically and chemically robust and easy to attach.

In a vaporizer as it is described herein, the temperature sensor and the heating element are in particular directly mechanically connected and thermally coupled to each other by a welded joint.

In particular, the welded joint is a spot weld. A welded joint can be producible in a quick, easy and cost-efficient way and mechanically and chemically robust.

In a vaporizer as it is described herein, the temperature sensor is in particular located at that point on the heating element that reaches the highest temperature during intended use.

During intended use, an intended current or an intended maximum current flows through the heating element. During intended use, the heating element is in particular in uniform thermal contact with fluid supplied, for example, by a wick and to be vaporized, and is cooled by the vaporized fluid. The point where the highest temperature is reached in the intended use depends on the geometry of the heating element, and, in case of doubt, can be determined empirically or by numerical simulation.

In a vaporizer as it is described herein, the temperature sensor is in particular located at the geometrical center of the heating element.

In case of a linear heating element, for example a straight or only slightly curved wire, the temperature sensor is located in particular in the central third or in the central fifth or in the central tenth of the length of the linear heating element. In case of a helical heating element, for example a wire helix, the temperature sensor is located in particular at a turn in the central third or in the central fifth or in the central tenth. In case of a two-dimensional heating element, for example a mesh or a grid, the temperature sensor is located in particular at the area center of the two-dimensional heating element. In case of a rectangular two-dimensional heating element, for example a mesh or a grid, the temperature sensor is located in particular in the central third or in the central fifth or in the central tenth with regard to both the length and a width of the two-dimensional heating element.

In a vaporizer as it is described herein, the heating element is in particular formed as a mesh or a grid, wherein the heating element comprises a full-surface area without holes, meshes or other recesses, and wherein the temperature sensor is directly mechanically connected and thermally coupled to the full-surface area of the heating element.

A full-surface area without holes, meshes or other recesses can significantly simplify the fixation of the temperature sensor, reduce scrap during production and significantly improve the reliability of the mechanical connection.

In a vaporizer as it is described herein, in particular a plurality of temperature sensors are spaced apart from each other and are each directly mechanically connected and thermally coupled to the heating element.

Employing a plurality of temperature sensors can significantly improve monitoring and control of the temperature of the heating element and can make it more secure. In particular, overheating of the heating element at a location where, for example, no or too little fluid reaches and where cooling by the vaporized fluid is therefore reduced or eliminated can be prevented.

A power source module comprises an interface for mechanical and electrical connection of the power source module to a corresponding interface of a vaporizer, a temperature measuring circuit for detecting a temperature signal of a temperature sensor directly thermally coupled to the heating element and a power source coupled to the temperature measuring circuit for providing electrical power to the heating element of the vaporizer in response to the temperature signal detected by the temperature measuring circuit.

The power source module is provided and configured to be a part of an electronic cigarette or for an electronic cigarette or for another electrical smoking or vaporizing system. The power source module can be configured to form, together with a vaporizer, an already complete and operational electronic cigarette or other already complete and operational electric smoking or vaporizing system. In particular, the power source module is provided and configured as a separately tradeable module (“battery carrier”) that can be combined, by an end user, with a vaporizer or vaporizer module easily and in particular without the use of a tool to form a complete ready-to-use electronic cigarette or other complete ready-to-use electric smoking or vaporizing system.

In particular, the power source module is provided and configured for combination with a vaporizer as it is described herein. For this purpose, the interface of the power source module is in particular provided and configured for the mechanical and electrical connection of the power source module with a corresponding interface of a vaporizer as it is described herein.

In a power source module as it is described herein, the interface in particular can comprise electrical power contacts for transferring electrical power via corresponding electrical power contacts of the vaporizer to the heating element of the vaporizer and electrical signal contacts for receiving a temperature signal from the temperature sensor of the vaporizer via corresponding signal contacts of the vaporizer.

In particular, both the power contacts and the signal contacts can be provided in pairs. In particular, the power contacts are arranged like in a conventional electronic cigarette, i.e. for example concentric, wherein the outer contact is formed by the housing, more precisely by an approximately circular rim of the housing or by a thread at that rim. In particular, the signal contacts are located at positions excluding confusion or unintentional contacting by power contacts of the vaporizer.

In a power source module as it is described herein, the temperature measuring circuit is in particular configured for detecting a difference between a thermoelectric voltage at a sensing junction of a thermocouple and a thermoelectric voltage of a reference junction, wherein the reference junction is formed by the signal contacts.

A power source module as it is described herein in particular further comprises a further temperature sensor for measuring the temperature of the reference junction, wherein the further temperature sensor is located between the signal contacts of the power source module.

The temperature sensor can be located between the signal contacts of the power source module if neither of the distances between the temperature sensor and each of the signal contacts is greater than the distance between the signal contacts.

Locating the temperature sensor between the signal contacts of the power source module, i.e. in their immediate vicinity, facilitates a particularly reliable detection of the temperature of the signal contacts forming the reference junction.

In a power source module as it is described herein, the temperature measuring circuit in particular comprises a high impedance linear or non-linear differential amplifier.

In a power source module as it is described herein, the temperature measuring circuit can be configured for detecting a temperature signal of a temperature sensor electrically conductively to the heating element of the vaporizer.

Detecting the temperature signal of a temperature sensor electrically conductively connected to the current-carrying heating element in particular requires an electrical insulation or a high impedance isolation of the temperature measuring circuit from the power source and the ports of the heating element.

In a power source module as it is described herein, the values of the electrical resistances between each of the signal contacts of the power source module and each of the power contacts of the power source module may be at least 10 kΩ or at least 100 kΩ.

In a power source module as it is described herein, the temperature measuring circuit in particular comprises its own power source galvanically insulated from the power contacts of the power source module.

The temperature measuring circuit's own power source in particular comprises a primary cell or a secondary cell or a capacitor.

In a power source module as it is described herein, the temperature measuring circuit in particular comprises an analog-to-digital converter and in integer computation of the digital output signal provided by the analog-to-digital converter.

Computation of integers is faster and requires less time and less energy than computation of floating point numbers.

In a power source module as it is described herein, the temperature measuring circuit and a power control coupled to the temperature measuring circuit are in particular of analog design.

Analog signal processing, i.e. signal processing without digitization, can be particularly fast and, thereby, facilitate a particularly precise control of the temperature of the heating element.

In a power source module as it is described herein, the interface of the power source module can comprise a decoder for decoding a target temperature encoded by the interface of the vaporizer module.

For example, the target temperature can be encoded mechanically, optically or electrically. A mechanical structure at the vaporizer encoding the target temperature can be scanned mechanically or optically by the decoder of the power source module. An optical code at the vaporizer, for example incorporated as QR-code or barcode, can be optically scanned by the decoder of the power source module. For example, a photo diode at the power source module can scan a barcode at the circumference of the vaporizer while the power source module is screwed to the vaporizer and the barcode passes by.

In a power source module as it is described herein, the signal contacts of the power source module are in particular arranged corresponding to predetermined optional positions of the signal contacts of the vaporizer, wherein the target temperature is encoded in the positions of the signal contacts at the interface of the vaporizer, and wherein the decoder is configured for decoding the target temperature based on the signal contacts of the power source module contacted by the signal contacts of the vaporizer.

For example, with one predetermined position of the first signal contact and three alternative predetermined positions of the second signal contact, three different target temperatures can be encoded by facultatively positioning the second signal contact of the vaporizer at one of the three predetermined positions.

In a power source module as it is described herein, in particular two or more signal contacts of the power source module can be positioned on a circle concentric to at least one power contact of the power source module.

An electrical smoking or vaporizing system comprises a vaporizer as it is described herein and a power source module as it is described herein.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of an electronic cigarette;

FIG. 2 shows another schematic representation of the electronic cigarette shown in FIG. 2;

FIG. 3 shows a schematic representation of an alternative embodiment of a heating element of the electronic cigarette shown in FIGS. 1 and 2; and

FIG. 4 shows a schematic representation of an interface of a battery carrier of the electronic cigarette shown in FIGS. 1 and 2.

### DETAILED DESCRIPTION

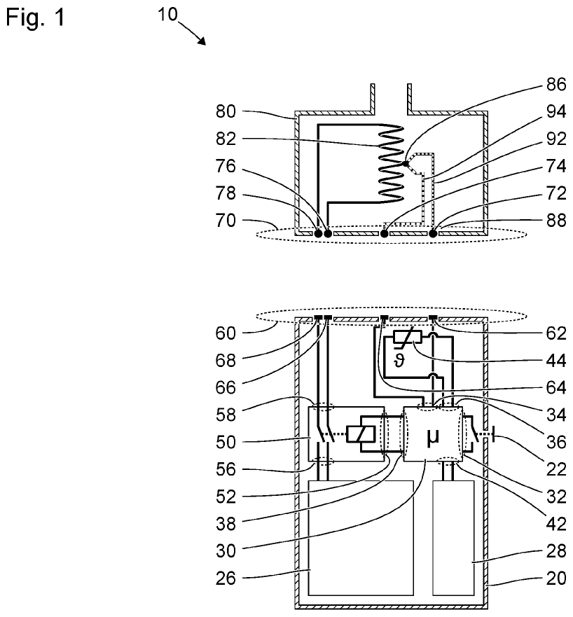

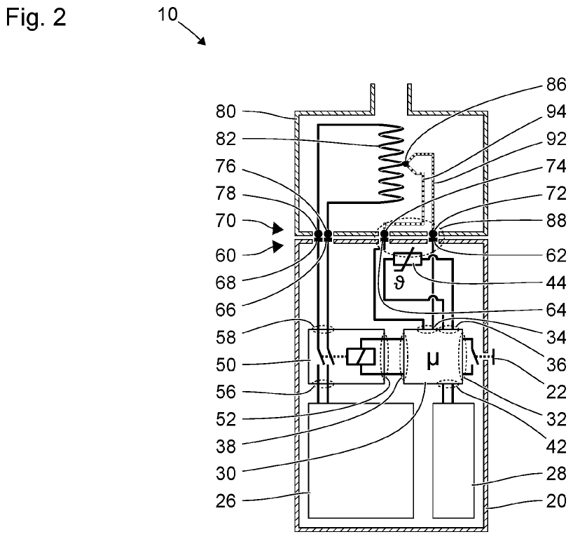

FIG. 1 shows a schematic representation of an electronic cigarette 10 as an example of an electric smoking or vaporizing system for generation of an inhalable aerosol from a liquid. The liquid and thus also the aerosol may contain nicotine and/or flavor or release them during vaporization. The electronic cigarette 10 comprises a battery carrier 20 and a vaporizer 80 shown spaced apart in FIG. 1 which can be mechanically and electrically connected to each other as described with reference to FIGS. 2. Housings of the battery carrier 20 and the vaporizer 80 are shown in a sectional view to make members and components inside the housing visible.

The battery carrier 20 is an example of a power source module for delivering electrical power to the vaporizer 80.

The battery carrier 20 comprises a user interface 22 for receiving a user input. In the example shown, the user interface 22 is formed by a simple electrical push button. By actuating the user interface, namely pressing the push button, a user can request the generation of aerosol.

The battery carrier 20 further comprises a first power source 26 and a second power source 28. The first power source 26 in particular comprises one or more secondary cells (also referred to as rechargeable battery) and is provided and configured for providing electrical power to the vaporizer 80. As an alternative, the first power source 26 can comprise one or more primary cells, fuel cells or other sources of electrical power.

In the example shown, the second power source 28 is provided and configured only for providing electrical power for the battery carrier itself and comprises one or more primary cells, for example. As an alternative, the second power source 28 may comprise one or more secondary cells or other power sources or one or more capacitors. As an alternative, the second power source 28 can comprise a circuit receiving electrical power from the first power source 26 and providing electrical power with a predetermined voltage substantially or entirely independent from the voltage of the first power source 26. In any case, the power output of the second power source 28 is galvanically isolated or high impedance insulated from the first power source 26.

The battery carrier 20 further comprises a temperature detecting and controlling device 30, in particular formed by a microcontroller or comprising a microcontroller. The temperature detecting and controlling device 30 comprises a first signal input 32 coupled to the user interface 22 for receiving a request signal from the latter. Further, the temperature detecting and controlling device 30 comprises a (high impedance) second signal input 34 for receiving an electrical voltage signal. Furthermore, the temperature detecting and controlling device 30 comprises a third signal input 36 connected to a temperature sensor 44, for receiving a temperature signal. Further, the temperature detection and control device 30 comprises a control signal output 38 for providing a control signal in response to the request signal, the voltage signal and the temperature signal. Further, the temperature detection and control device 30 comprises a power input 42 connected to the second power source 28, for receiving electrical power.

The battery carrier 20 further comprises a power control 50. The power control 50 comprises a control signal input 52 coupled to the control signal output 38 of the temperature detection and control device 30, for receiving the control signal provided by the temperature detection and control device 30. Further, the power control 50 comprises a power input 56 connected to the first power source 26, for receiving electrical power provided by the first power source 26. Further, the power control 50 comprises a power output 58 for providing electrical power controlled by the control signal received at the control signal input 52 from the temperature detection and control device 30.

As an example, the power control 50 is depicted as a relay. For example, the power control 50 comprises a semiconductor relay for connecting the control output 58 to the control input 56. As an alternative, the power control 50 is provided and configured not only for switching provided power on and off, but for controlling power delivered in a plurality or in many steps or continuously between a predetermined minimum value (in particular zero) and a predetermined maximum value.

The control signal input 52 of the power control 50 on the one hand side and the power inputs and outputs 56, 58 of the power control 50 on the other hand are high-impedance insulated or galvanically isolated, for example by means of an optocoupler. As an alternative, the control signal output 38 of the temperature detecting and controlling device 30 on the one hand side and the second signal input 34 of the temperature detecting and controlling device 30 on the other hand are high-impedance insulated or galvanically isolated, for example by means of an optocoupler. The resulting high impedance insulation or galvanical isolation of the second signal input 34 from the power inputs and outputs 56, 58 of the power control 50 facilitates detection of a voltage provided at the second signal input 34 largely or completely independent of electrical voltages between the second signal input 34 and the power inputs and outputs 56, 58 of the power control 50.

The battery carrier 20 further comprises an interface 60 for mechanical and electrical connection to a corresponding interface 70 of a vaporizer 80 of the electronic cigarette 10. The mechanical connection can be, for example, one or more screw threads, a swivel connection (often also referred to as a bayonet connection), a snap-in connection or magnets.

The interface 60 of the battery carrier 20 comprises a first signal contact 62 and a second signal contact 64 connected to the second signal input 34 and a first power contact 66 and a second power contact 68 connected to the power output 58 of the power control 50.

The interface 70 of the vaporizer 80 comprises a first signal contact 72 and a second signal contact 74 corresponding to the first signal contact 62 and the second signal contact 64, respectively, of the interface 60 of the battery carrier 20. The first signal contact 72 of the interface 70 of the vaporizer 80 is connected to the second contact 74 of the interface 70 of the vaporizer 80 by means of a first conductor 92 from a first material and a second conductor 94 from a second material different from the first material. Due to the Seebeck effect, at each junction between two different materials, a thermoelectric voltage depending on the temperature of the junction accrues. The direct connection of both conductors 92, 94 is referred to as sensing junction 86 often also shortened as thermocouple.

The interface 70 of the vaporizer 80 further comprises a first power contact 76 and a second power contact 78 corresponding to the first power contact 66 and the second power contact 68 of the interface 60 of the battery carrier. The power contacts 76, 78 of the interface 70 of the vaporizer 80 are connected by a heating element 82 for receiving electrical power and providing thermal power. In the example shown, the heating element 82 is a helix made from resistance wire.

FIG. 2 shows a further schematic representation of the battery carrier 20 and the vaporizer 80. The form of representation, in particular the position of the drawing plane, corresponds to that of FIG. 1. The representation in FIG. 2 differs from the representation in FIG. 1 in that the battery carrier 20 and the vaporizer 80 are mechanically connected to each other in a manner not shown, such that the first signal contact of the interface 60 of the battery carrier 20 touches the first signal contact 72 of the interface 70 of the vaporizer 80, the second signal contact 64 of the interface 60 of the battery carrier 20 touches the second signal contact 74 of the interface 70 of the vaporizer 80, the first power contact 66 of the interface 60 of the battery carrier 20 touches the first power contact 76 of the interface 70 of the vaporizer 80 and the second power contact 68 of the interface 60 of the battery carrier 20 touches the second power contact 78 of the interface 70 of the vaporizer 80.

The signal contacts 62, 64 of the interface 60 of the battery carrier 20 and the signal contacts 72, 74 of the interface 70 of the vaporizer 80 form a reference junction 88 the temperature of which is detected by the temperature sensor 44. For this purpose, the signal contacts 62, 64, 72, 74 are arranged within as small a volume of space as possible and are thermally coupled to one another as well as possible. Furthermore, the temperature sensor 44 is located as close as possible to the signal contacts 62, 64, 72, 74, in particular between them or in their immediate vicinity.

If and in so far as within the battery carrier 27 the two conductors between the signal contacts 72, 74 and the second signal input 34 of the temperature detection and control device 30 can be formed of the same material—for example copper—a difference between the thermoelectric voltages at the sensing junction 86 and at the reference junction 88 is applied to the high-impedance second signal input 34 of the temperature detection and control device 30. The temperature detection and control device 30 calculates the thermoelectric voltage accruing at the reference junction 88 from the temperature of the reference junction 88 detected by means of the temperature sensor 44, calculates the thermoelectric voltage accruing at the sensing junction 86 from the thermoelectric voltage at the reference junction 88 and the voltage at the second signal input 34 detected by the temperature detection and control device 30, and calculates from the thermoelectric voltage accruing at the sensing junction 86 the temperature of the sensing junction 86.

The sensing junction 86 is directly mechanically and thus also thermally connected to the heating element 82 by means of spot weld. Since the sensing junction 86 itself, as a small-volume connection of two thin conductors 92, 94, has low thermal inertia and is directly thermally coupled to the heating element 82, the arrangement shown permits an extremely low-delay, i.e. fast and at the same time precise, detection of the temperature of the heating element 82.

The sensing junction 86 is located at the center of the heating element 82, where the highest temperature of the heating element 82 can be expected. This arrangement facilitates a reliable detection of the maximum temperature of the heating element 82.

When the temperature detection and control device receives at its first signal input 32 a request signal caused by a user at the user interface 22, the temperature detection and control device 30 at its control signal output 38 provides a control signal controlling the power control 50 such that the heating element is heated to a predetermined maximum temperature and then maintained at that maximum temperature.

As mentioned above and shown in FIGS. 1 and 2, the second signal input 34 of the temperature detection and control device 30 can be galvanically isolated from the power inputs and outputs 56, 58 of the power control 50 and thus also from the first power source 26 and, with regard to the connection via the power control 50, from the heating element. Alternatively, and contrary to the illustration in FIG. 1, there may be a high impedance connection (particularly at least 10 kΩ or at least 100 kΩ) between the power input 42 of the temperature detection and control device 30 and the power input 56 of the power control and/or between the control signal output 38 of the temperature detection and control device 30 and the control signal input 52 of the power control. This may allow for omission of optocouplers and/or omission of primary or secondary cells or the like in the second power source 28 for the temperature detection and control device 30. Instead, the second power source 28 may receive electrical power from the first power source 26.

Both galvanic isolation and a high-impedance connection can facilitate accurate detection of small differences (typically in the order of one mV) of the small thermoelectric voltages at the sensing junction 86 and the reference junction 88 even if the sensing junction 86 is galvanically connected to the heating element 82 by the spot weld.

However, an advantage of the configuration shown in FIGS. 1 and 2 with a separate power source 28 for the temperature detection and control device 30 may be that retroactive effects from fluctuations in the output voltage of the first power source 26 on the temperature detection and control device 30 can be avoided even without special circuitry.

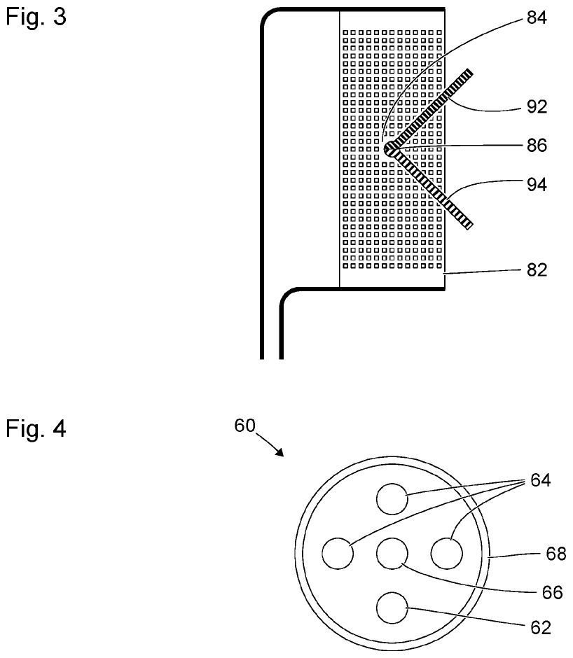

FIG. 3 shows a schematic representation of an alternative embodiment of a heating element 82. The heating element 82 shown in FIG. 3 is configured as a flat rectangular mesh or grid with numerous recesses or openings or holes. In the center of the heating element 82 a full-surface region 84 without recesses or openings or holes is provided. The sensing junction 86 is located at the full-surface region 84 to which it can be connected in a particularly reliable and permanent manner, for example by a spot weld.

Unlike the illustration in FIG. 3, the first conductor 92 and the second conductor 94 can be connected to each other at multiple locations, i.e. at multiple sensing junctions 86. In this case, the multiple sensing junctions 86 are in particular arranged along an equipotential line, i.e. a line orthogonal to the current flow and current density distribution in the heating element 82. In this way it can be avoided that a part of the current flowing through the heating element 82 for ohmic heating flows through the conductors 92, 94.

However, it is advantageous for the conductors 92, 94 to be conductively connected to the heating element 82 only at the sensing junction 86 or the sensing junctions 86. For example, if only one of the conductors 92, 94 is electrically conductively connected to the heating element 82 at a further location that is not on an equipotential line with the sensing junction 86 or the sensing junctions 86, part of the current provided for ohmic heating of the heating element 82 flows through the conductor 92, 94 and, due to its resistance, generates a voltage that may distort the detection of the thermoelectric voltage and/or destroy the temperature detection and control device 30.

Many electrically insulating materials, in particular mechanically flexible and at the same time electrically insulating materials, can emit harmful substances when heated. Therefore, the conductors 92, 94 are in particular not electrically insulated. In this case, avoidance of electrically conductive contact between the heating element 82 and a conductor 92, 94 away from the sensing junction 86 or sensing junctions 86 can be ensured by the spatial arrangement and the shape of the conductors 92, 94.

FIG. 4 shows a schematic representation of the interface 60 of the battery carrier 20. The drawing plane of FIG. 4 is orthogonal to the drawing planes of FIGS. 1 and 2.

In the example shown, the interface 60 is circular. The power contacts 66, 68 are arranged concentric, wherein power contact 66 is located in the center and the other power contact is circular in shape and, for example, located at the rim of the housing of the battery carrier 20. Furthermore, one of the power contacts 66, 68 can be configured as a thread for a detachable mechanical connection of the battery carrier 20 to the vaporizer.

The interface 60 of the battery carrier 20 comprises a first signal contact 62 and three second signal contacts 64. In the example shown, all signal contacts 62, 64 are located on a circular circumference concentric with the power contacts 66, 68. The three second signal contacts 64 are provided for alternative contacting by a single second signal contact 74 of the interface 70 of the vaporizer 80 (cf. FIGS. 1, 2). The arrangement of the second signal contact 74 of the interface 70 of the vaporizer 80 corresponding to one of the second signal contacts 64 of the interface 60 of the battery carrier 20 encodes one of three alternatively provided target or maximum temperatures. The temperature detection and control device 30 decodes the intended target or maximum temperature of the vaporizer by detecting which of the second signal contacts 64 is contacted by the second signal contact 74 of the interface 70 of the vaporizer 80.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A vaporizer for vaporizing a liquid, the vaporizer comprising:
a heating element to receive electrical power and to deliver thermal power to a liquid to be vaporized; and
a temperature sensor to sense the temperature of the heating element, the temperature sensor and the heating element being directly mechanically connected and thermally coupled.

2. The vaporizer according to claim 1, wherein the temperature sensor and the heating element are electrically conductively connected.

3. The vaporizer according to claim 1, wherein the temperature sensor comprises a sensing junction of a thermocouple.

4. The vaporizer according to claim 1, wherein the temperature sensor and the heating element are directly mechanically connected and thermally coupled to each other by a welded joint.

5. The vaporizer according to claim 1, wherein the heating element is formed as a mesh or grid, wherein the heating element comprises a full-surface region without holes, meshes or other recesses, and wherein the temperature sensor is directly mechanically connected and thermally coupled to the full-surface region of the heating element.

6. The vaporizer according to claim 1, wherein a plurality of temperature sensors are spatially distanced from one another and are each directly mechanically connected and thermally coupled to the heating element.

7. A power source module comprising:
an interface to mechanically and electrically connect the power source module to a corresponding interface at a vaporizer comprising a heating element to receive electrical power and to deliver thermal power to a liquid to be vaporized and a temperature sensor to sense the temperature of the heating element, the temperature sensor and the heating element being directly mechanically connected and thermally coupled;
a temperature measuring circuit to detect a temperature signal of the temperature sensor; and
a power source coupled to the temperature measuring circuit to provide electrical power to the heating element of the vaporizer in response to the temperature signal detected by the temperature measuring circuit.

8. The power source module according to claim 7, wherein the interface of the power source module includes electrical power contacts to transmit electrical power via corresponding electrical power contacts of the vaporizer to the heating element of the vaporizer and electrical signal contacts to receive a temperature signal from the temperature sensor of the vaporizer via the corresponding signal contacts of the vaporizer.

9. The power source module according to claim 8, wherein the temperature measuring circuit is configured to detect a difference of a thermoelectric voltage at a thermocouple's sensing junction and a thermoelectric voltage at a reference junction, the reference junction being formed by the signal contacts.

10. The power source module according to claim 9, further comprising a further temperature sensor to sense the temperature of the reference junction, wherein the further temperature sensor is arranged between the signal contacts of the power source module.

11. The power source module according to claim 7, wherein the temperature measuring circuit comprises a high impedance linear or non-linear differential amplifier.

12. The power source module according to claim 7, wherein the temperature measuring circuit is configured to detect a temperature signal of a temperature sensor electrically conductively connected to the heating element of the vaporizer.

13. The power source module according to claim 7, wherein the temperature measuring circuit comprises its own power source galvanically insulated from the power contacts of the power source module.

14. The power source module according to claim 7, wherein the temperature measuring circuit comprises an analog-to-digital converter and an integer computation of the digital output signal provided by the analog-to-digital converter.

15. The power source module according to claim 7, wherein the temperature measuring circuit and a power control coupled to the temperature measuring circuit are of analog design.

16. The power source module according to claim 7, wherein the interface of the power source module comprises a decoder to decode a target temperature encoded by the interface of the vaporizer module.

17. The power source module according to claim 16, wherein the signal contacts of the power source module are positioned corresponding to predetermined optional positions of the signal contacts of the vaporizer, the target temperature is encoded in the positions of the signal contacts at the interface of the vaporizer, the decoder is configured to decode the target temperature on the basis of the signal contacts of the power source module which are contacted by the signal contacts of the vaporizer.

18. The power source module according to claim 7, wherein two or more signal contacts of the power source module are positioned on a circle concentric to at least one power contact of the power source module.

19. An electric smoking or vaporizing system comprising:
a vaporizer comprising a heating element to receive electrical power and to deliver thermal power to a liquid to be vaporized and a temperature sensor to sense the temperature of the heating element; and
a power source module comprising:
an interface to mechanically and electrically connect the power source module to a corresponding interface at the vaporizer;
a temperature measuring circuit to detect a temperature signal of a temperature sensor directly mechanically connected and thermally coupled to the heating element of the vaporizer; and
a power source coupled to the temperature measuring circuit to provide electrical power to the heating element of the vaporizer in response to the temperature signal detected by the temperature measuring circuit.
